(19) United States
(12) Patent Application Publication
(10) Pub. No.: US 2025/0225149 A1
(43) Pub. Date: Jul. 10, 2025

(54) SCALABLE MULTIMODAL CODE CLASSIFICATION

(71) Applicant: Walmart Apollo, LLC, Bentonville, AR (US)

(72) Inventors: Govind Saria, Bengaluru (IN); Sandip Bhattacharjee, Bangalore (IN); S L Narasimha Rao Appana, Bengaluru (IN)

(21) Appl. No.: 18/405,161

(22) Filed: Jan. 5, 2024

(51) Int. Cl. G06F 16/28; G06F 16/22

(52) U.S. Cl. CPC G06F 16/285; G06F 16/2246; G06V 10/82

(57) ABSTRACT

Systems and methods of determining and transmitting a code designation are disclosed. A request for a code designation of an item, and information about the item are received. A first probability distribution is obtained via a trained text classification model from the textual description. A second probability distribution is obtained via a trained image classification model, from the one or more images. A plurality of candidate code designations based on the first probability distribution and the second probability distribution are generated. Each candidate code designation includes a first portion and a second portion of the code designation. Respective probabilities of respective candidate code designations in a first subset of the plurality of candidate code designations are aggregated, from which a selected code designation is transmitted to the requesting system as the code designation associated with the item.

### TECHNICAL FIELD

This application relates generally to determining a code designation, and more particularly, to determining a code classification associated with an item.

### BACKGROUND

Using the correct Harmonized Tariff Schedule (HTS) code classification for an item may allow smoother customs processes and may enhance adherence to trade regulations for an item that is traded across borders. Misclassification of HTS codes and the payment of incorrect customs duties at borders can result in non-compliance penalties, border delays, product seizures, or even the revocation of import privileges. In addition to HTS code classification, Harmonized System (HS) code is another way for standardizing codes to declare the identity of an item to the customs. A standard (e.g., a universal or globally standardized) HS code includes six digits (e.g., HS-6, which is globally standardized in over two hundred countries), and the first six digits of an HTS code is its corresponding HS code. An HTS code includes seven to 15 digits (e.g., a 10-digit HTS may also be denoted as HS-10, an eight-digit HTS may be denoted as HS-8, a 12-digit HTS may be denoted as HS-12, etc.). For example, a HTS has additional (e.g., two, three, four, six, etc.) different ending digits compared to its corresponding HS code.

### SUMMARY

In various embodiments, a system is disclosed. The system includes a non-transitory memory, a database configured to store a trained text classification model, and a trained image classification model. The processor is configured to read a set of instructions to receive a request for a code designation of an item from a requesting system, receive a textual description and one or more images associated with the item from the requesting system, obtain a first probability distribution associated with a first portion of the code designation from the textual description via the trained text classification model, obtain a second probability distribution associated with the first portion of the code designation from the one or more images via the trained image classification model, and generate a plurality of candidate code designations based on the first probability distribution and the second probability distribution. Each candidate code designation in the plurality of candidate code designations includes the first portion of the code designation and a second portion of the code designation. The processor is further configured to read a set of instructions to aggregate respective probabilities of respective candidate code designations in a first subset of the plurality of candidate code designations, and, in accordance with a determination that an aggregated probability of the first subset of the plurality of candidate code designations is larger than a threshold, transmit a selected code designation from the first subset of the plurality of candidate code designations to the requesting system as the code designation associated with the item.

In various embodiments, a computer-implemented method is disclosed. The computer-implemented method includes the steps of receiving a request for a code designation of an item from a requesting system, receiving a textual description and one or more images associated with the item from the requesting system, obtaining a first probability distribution associated with a first portion of the code designation from the textual description via a trained text classification model, obtaining a second probability distribution associated with the first portion of the code designation from the one or more images via a trained image classification model, generating a plurality of candidate code designations based on the first probability distribution and the second probability distribution, aggregating respective probabilities of respective candidate code designations in a first subset of the plurality of candidate code designations, and, in accordance with a determination that an aggregated probability of the first subset of the plurality of candidate code designations is larger than a threshold, transmitting a selected code designation from the first subset of the plurality of candidate code designations to the requesting system as the code designation associated with the item. Each candidate code designation in the plurality of candidate code designations includes the first portion of the code designation and a second portion of the code designation.

In various embodiments, a non-transitory computer-readable medium having instructions stored thereon is disclosed. The instructions, when executed by a processor, cause a device to perform operations including receiving a request for a code designation of an item from a requesting system, receiving a textual description and one or more images associated with the item from the requesting system, obtaining a first probability distribution associated with a first portion of the code designation from the textual description via a trained text classification model, obtaining, a second probability distribution associated with the first portion of the code designation from the one or more images via a trained image classification model, generating a plurality of candidate code designations based on the first probability distribution and the second probability distribution, aggregating respective probabilities of respective candidate code designations in a first subset of the plurality of candidate code designations, and, in accordance with a determination that an aggregated probability of the first subset of the plurality of candidate code designations is larger than a threshold, transmitting a selected code designation from the first subset of the plurality of candidate code designations to the requesting system as the code designation associated with the item. Each candidate code designation in the plurality of candidate code designations includes the first portion of the code designation and a second portion of the code designation.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide a code designation of an item, in accordance with some embodiments;

FIG. 2 illustrates a computer system configured to implement one or more processes, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a code designation determination method, in accordance with some embodiments;

FIG. 7 is a process flow illustrating various steps of the code designation determination method of FIG. 6, in accordance with some embodiments;

FIG. 8 is a process flow illustrating a code designation determination method, in accordance with some embodiments;

FIG. 9 illustrates a text classification model, in accordance with some embodiments;

FIG. 10 illustrates an image classification model, in accordance with some embodiments;

FIG. 11A illustrates an example country-specific classifier, in accordance with some embodiments;

FIG. 11B illustrates example post-processing techniques, in accordance with some embodiments;

FIG. 12 is a process flow illustrating various steps of the code designation determination method of FIG. 6, in accordance with some embodiments;

FIG. 13 is a flowchart illustrating a training method for generating a trained machine learning model, in accordance with some embodiments; and

FIG. 14 is a process flow illustrating various steps of the training method of FIG. 13, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for determining a code designation associated with an item. In various embodiments, a request for a code designation of an item, and information about the item are received. A first probability distribution is obtained via a trained text classification model from a textual description and a second probability distribution is obtained via a trained image classification model from one or more images. A plurality of candidate code designations based on the first probability distribution and the second probability distribution are generated. Each candidate code designation includes a first portion and a second portion of a code designation. Respective probabilities of respective candidate code designations in a first subset of the plurality of candidate code designations are aggregated, from which a selected code designation is transmitted to the requesting system as the code designation associated with the item.

In some embodiments, systems and methods for determining a code designation of an item with higher accuracy and without manual intervention includes one or more trained multilingual text classification models, trained image classification models, and multimodal fusion models. The trained multilingual text classification model and/or the trained image classification model may include one or more models, such as multilingual MPNet model with Sentence-Transformers, such as paraphrase-multilingual-mpnet-base-v2, masked language modeling (MLM), permuted language modeling (PLM), ConvNeXt V2 image model, etc.

To mitigate the risks of misclassifying code designations (e.g., HTS codes or HS codes), items are auto-classified with respective HTS codes if a prediction confidence for the code designation is greater than a threshold (e.g., a prediction confidence greater than 80%, a prediction confidence greater than 90%, a prediction confidence greater than 95%). In this way, additional safeguards are provided to ensure that the deep learning framework described herein can be used to determine code designations (e.g., HTS codes or HS codes) with high accuracy and high confidence level. A code designation may have additional uses besides labeling an item. For example, the code designation may correspond to export-control classification numbers, and may help ensure that restricted technologies, products, or services are not exported to specific countries.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate a respective code designation (e.g., HTS codes, or HS codes) associated with an item, are disclosed. A neural network trained to generate a respective code designation associated with an item may be referred to as a trained code designation determination model. A trained code designation determination model may be configured to receive a set of input data, such as a textual description and one or more images associated with the item for which the code designation is to be determined.

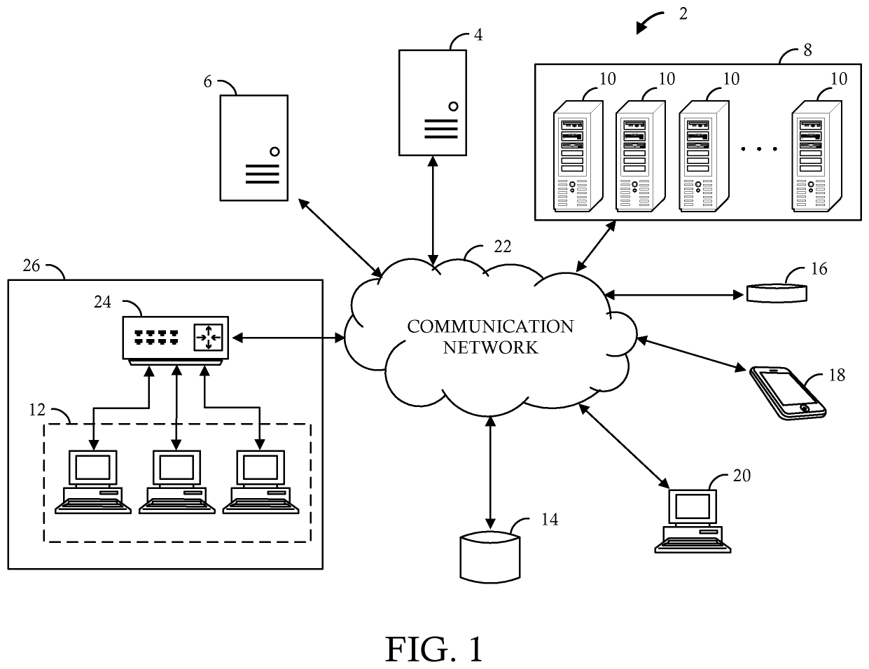

FIG. 1 illustrates a network environment 2 configured to provide a code designation (e.g., a HTS code, or a HS code) associated with an item, in accordance with some embodiments. The network environment 2 includes a plurality of devices or systems configured to communicate over one or more network channels, illustrated as a network cloud 22. For example, in various embodiments, the network environment 2 may include, but is not limited to, a code designation determination computing device 4, a web server 6, a cloud-based engine 8 including one or more processing devices 10, workstation(s) 12, a database 14, and/or one or more user computing devices 16, 18, 20 operatively coupled over the network 22. The code designation determination computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the code designation determination computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the code designation determination computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the code designation determination computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the code designation determination computing device 4, for example. The workstation(s) 12 may communicate with the code designation determination computing device 4 over the communication network 22. The workstation(s) 12 may send data to, and receive data from, the code designation determination computing device 4.

Although FIG. 1 illustrates three user computing devices 16, 18, 20, the network environment 2 may include any number of user computing devices 16, 18, 20. Similarly, the network environment 2 may include any number of the code designation determination computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the code designation determination computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as a code designation determination website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as identifying and transmitting an item for code designation. The website may capture these activities as user session data, and transmit the user session data to the code designation determination computing device 4 over the communication network 22. The website may also allow the user to interact with one or more of interface elements to perform specific operations, such as uploading one or more items for code designation. In some embodiments, the web server 6 transmits user interaction data identifying interactions between the user and the website to the code designation determination computing device 4.

In some embodiments, the code designation determination computing device 4 may execute one or more models, processes, or algorithms, such as a machine learning model, deep learning model, statistical model, etc., to provide a code designation (e.g., a HTS code, or a HS code) associated with an item in response to a user's request for the code designation. The code designation determination computing device 4 may transmit the user's request for the code designation to the web server 6 over the communication network 22, and the web server 6 may display interface elements associated with receiving input information (e.g., from the user, or automatically retrieved from one or more databases) about the item on the website to the user. For example, the web server 6 may display interface elements associated with prompting the user to provide textual description or image information associated with an item displayed on a homepage, a catalog webpage, an item webpage, a window or interface of a chatbot, a search results webpage, or a post-transaction webpage of the website (e.g., as the user browses those respective webpages).

In some embodiments, the web server 6 transmits a code designation determination request to the code designation determination computing device 4. The code designation determination request may be a prompt on a webpage for listing an item in a database (e.g., a database of items for sale, or a database of items in an inventory), in which the code designation is a data element that is included for completing a profile of the item.

In some embodiments, a user submits a code designation request on a website hosted by the web server 6. The web server 6 may send a code designation determination request to the code designation determination computing device 4. In response to receiving the code designation determination request, the code designation determination computing device 4 may execute one or more processes to determine a code designation associated with an item and transmit the results including the determined code designation associated with the item to the web server 6 to be displayed to the user.

The code designation determination computing device 4 is further operable to communicate with the database 14 over the communication network 22. For example, the code designation determination computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the code designation determination computing device 4, in some embodiments, the database 14 may be a local storage device, such as a hard drive, a non-volatile memory, or a USB stick. The code designation determination computing device 4 may store interaction data received from the web server 6 in the database 14. The code designation determination computing device 4 may also receive from the web server 6 user session data identifying events associated with browsing sessions, and may store the user session data in the database 14.

In some embodiments, the code designation determination computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The code designation determination computing device 4 and/or one or more of the processing devices 10 may train one or more models based on corresponding training data. The code designation determination computing device 4 may store the models in a database, such as in the database 14 (e.g., a cloud storage database).

The models, when executed by the code designation determination computing device 4, allow the code designation determination computing device 4 to determine a relevant code designation that is associated with an item. For example, the code designation determination computing device 4 may obtain one or more models from the database 14. The code designation determination computing device 4 may then receive, in real-time from the web server 6, textual information and/or image information associated with the item. In response to receiving textual information and/or image information associated with the item, the code designation determination computing device 4 may execute one or more models to determine a relevant code designation that is associated with the item.

In some embodiments, the code designation determination computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, code designation determination computing device 4 may generate a relevant code designation that is determined to be associated with an item.

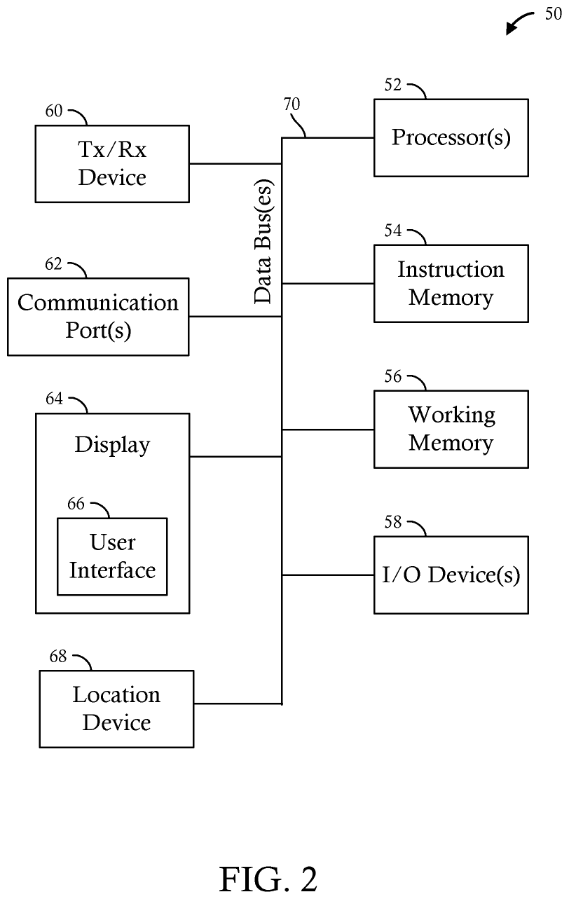

FIG. 2 illustrates a block diagram of a computing device 50, in accordance with some embodiments. In some embodiments, each of the code designation determination computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for determining a code designation (e.g., a HTS code, a HS code, etc.) for an item, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with providing input information (e.g., textual information, image information) associated with an item for which a code designation is to be determined. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

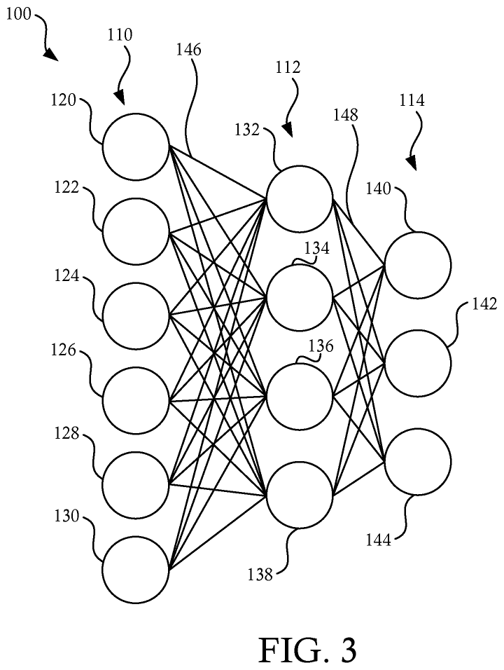

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ (n) is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

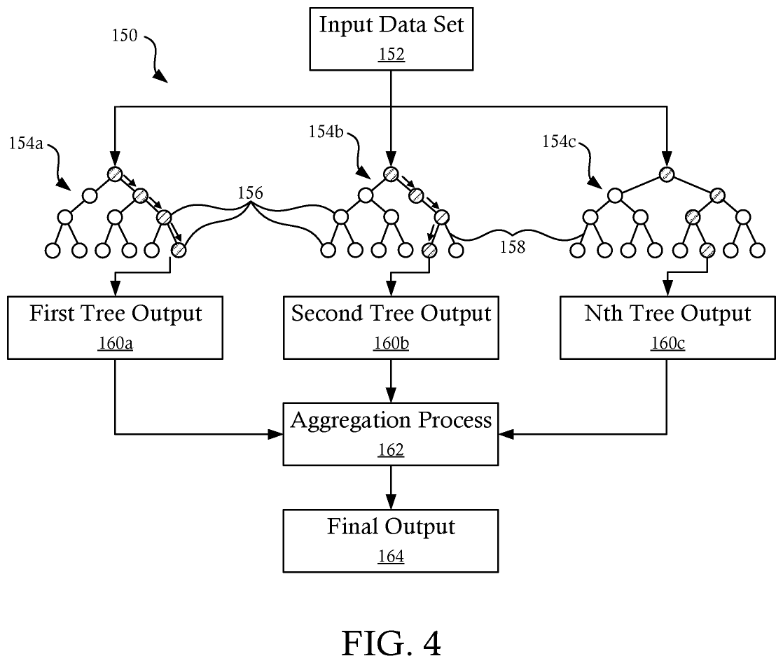

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each node (or leaf) 156 represents class labels and each of the branches (or edges) 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

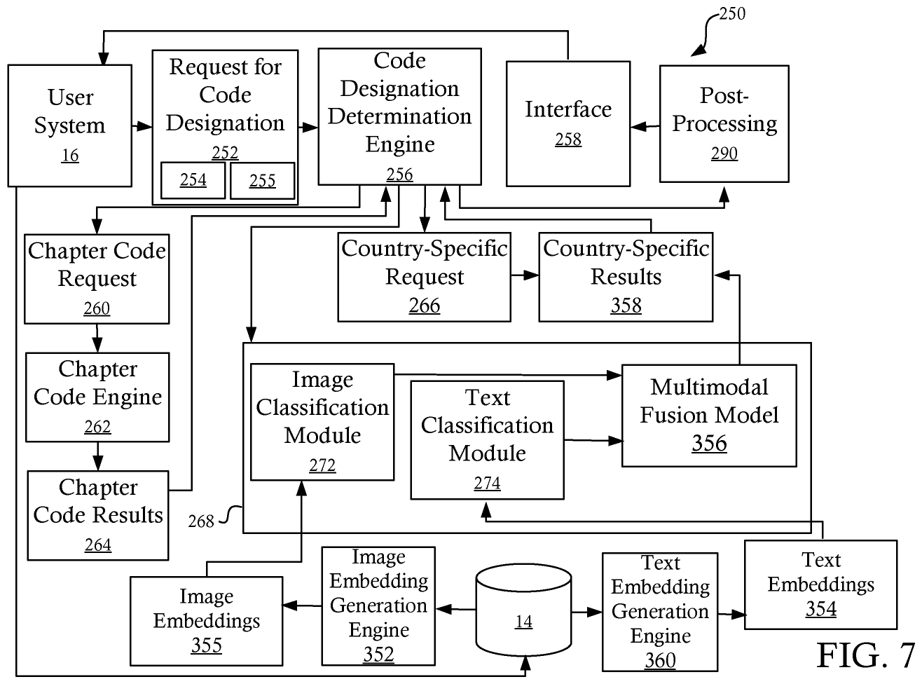

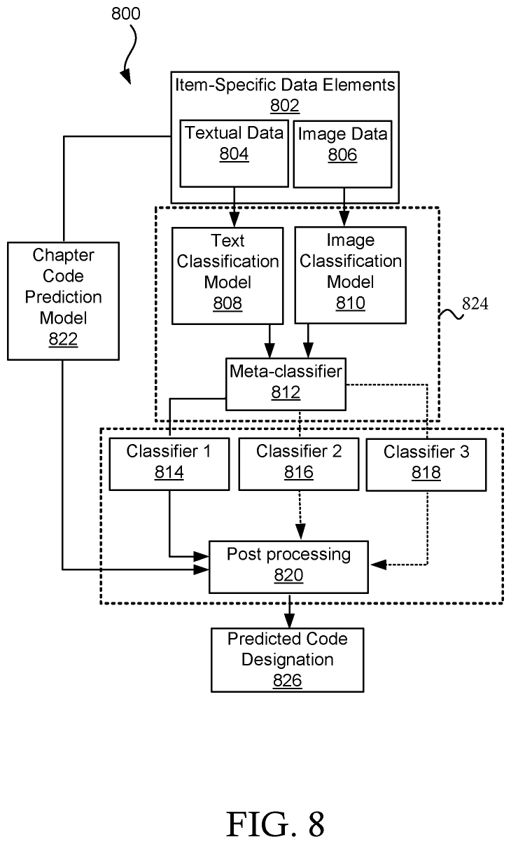

In some embodiments, the tree-based neural network 150 applies an aggregation process 162 to combine the output of the multimodal fusion model 356 (e.g., described in reference to FIGS. 7 and 8 into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

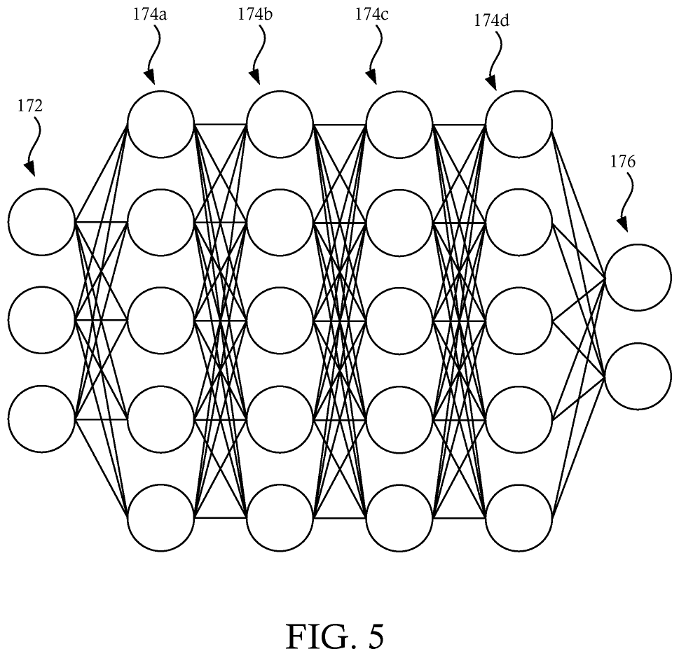

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ... ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( logx )} {e}^{{\sum }_{i} {f}_{i}^{d} ( {d}_{i} )}$$

where d represents one or more features of the independent variable x.

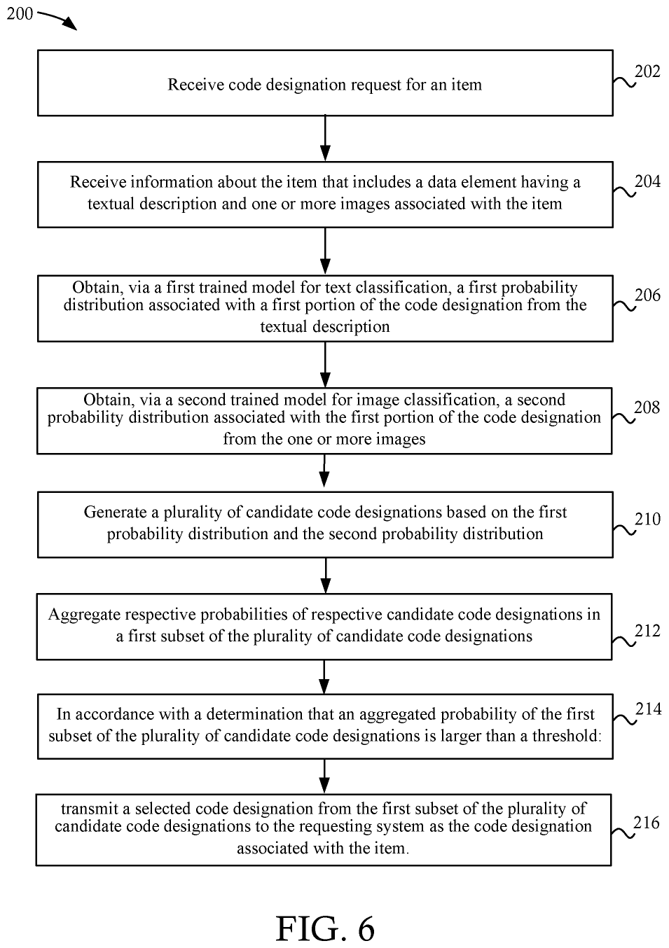

FIG. 6 is a flowchart illustrating a code designation determination method 200, in accordance with some embodiments. FIG. 7 is a process flow 250 illustrating various steps of the code designation determination method 200, in accordance with some embodiments. At step 202, a request 252 for a code designation of an item is received. The request 252 for the code designation of the item can be received by any suitable system and/or engine, such as, for example, a code designation determination engine 256. In some embodiments, the request 252 is generated by a remote system, such as a user computing device 16, 18, 20, although it will be appreciated that a request 252 for a code designation of an item can be generated locally and/or in response to other processes. In some embodiments, the request 252 for the code designation of the item includes one or more data elements 254 representative of information about the item, such as data elements representative of a textual description and/or one or more images associated with the item. The information about the item can be provided by the user via a user computing device 16, 18, 20 or retrieved (e.g., automatically, in response to the request 252, etc.) from one of more databases.

In some embodiments, the request 252 includes user signals representative of one or more user session features for a user session corresponding to generation of the request 252 for determining a code designation. In some embodiments, user signals can be generated using any suitable mechanism, such as, for example, a cookie, beacon, and/or other data element generated by and/or stored on a user computing device 16, 18, 20. In some embodiments, user signals can be generated by a server or other network interface device, such as a web server 6, based on interactions between a user device and a network interface.

At step 204, data 254 representative of the item, such as a data element 254 representative of a textual description and one or more images associated with the item, is received and provided to a code designation determination engine 256 and/or a database 14. The code designation determination engine 256 is configured to generate an interface 258 or a user interface element that includes content responsive to the code designation request 252 (e.g., a code designation for a specified item). For example, in some embodiments, the code designation determination engine 256 is configured to generate an interface 258 that includes at least one code designation for a specified item that is responsive to the code designation request 252.

In some embodiments, the code designation request may be related to one or more item(s) stored in an item catalog associated with the network platform. For example, in the context of an e-commerce platform, code designation requests may be generated for items in an item catalog of items sold by the e-commerce platform. The items may include data elements, such as image and/or text data representative of the underlying item, associated therewith.

At step 206, a first probability distribution associated with a first portion of the code designation is obtained. In some embodiments, the first probability distribution is generated by a trained text classification model 274. The trained text classification model 274 may be configured to generate a first probability distribution based on textual descriptions of the item, for example, as represented by a data element 254.

The trained text classification model 274 may receive text embeddings 354 generated by a text embedding generation engine 360. The text embedding generation engine 360 may be configured to receive a textual description associated with the item, from a storage mechanism, such as database 14. In some embodiments, the database 14 stores information about the item that is provided by a user computing device 16, 18, 20.

At step 208, a second probability distribution associated with the first portion of the code designation is obtained. In some embodiments the second probability distribution is generated by a trained image classification model. The image classification model may be configured to generate the second probability distribution based on image data of the item, for example, as represented by a data element 254. For example, in some embodiments, the code designation determination engine 256 generates a portion of the code designation responsive to the code designation request 252. The trained image classification model 272 may receive image embeddings 355 generated by an image embedding generation engine 352. The image embedding generation engine 352 is configured to receive one or more images associated with the item, for example, from a storage mechanism, such as database 14. Although specific embodiments are discussed herein, it will be appreciated that any suitable process can be used to generate embeddings.

At step 210, a set of candidate code designations based on the first probability distribution and the second probability distribution is generated. For example, in some embodiments, a partial code designation determination engine 268 generates, via a multimodal fusion model 356 that receives the output of the image classification module 272 and the text classification module 274, a portion of the code designation responsive to a query 255 associated with the request 252 for a code designation.

At step 212, probabilities of respective candidate code designations in a first subset of the plurality of candidate code designations are aggregated (e.g., summed) to determine if a confidence threshold associated with the result is met. In some embodiments, the probability output is derived from a same layer or same distribution, and simple addition is used to aggregate the probabilities. At step 214, in accordance with a determination that an aggregated probability of the first subset of the plurality of candidate code designations is larger than a threshold, then at step 216, a selected code designation from the first subset of the plurality of candidate code designations is transmitted to the requesting system as the code designation associated with the item.

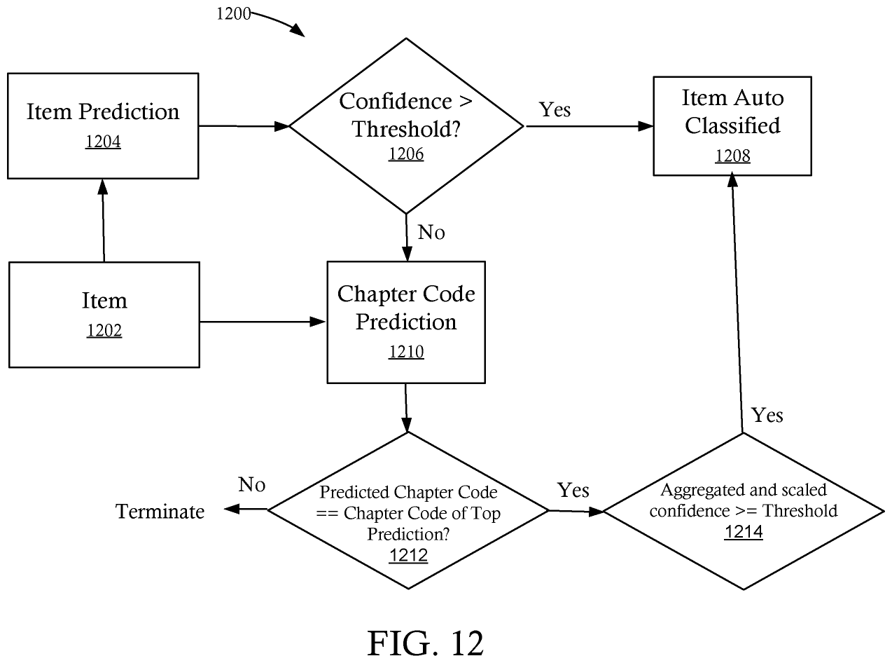

In some embodiments, the code designation determination engine 256 generates, in parallel, a chapter code request 260, which is provided to a chapter code engine 262, as part of post processing 820, described below in reference to FIG. 8 and FIG. 12. The chapter code engine 262 is configured to generate a set of chapter code results 264 responsive to the chapter code request 260. The chapter code engine 262 may be configured to implement one or more trained machine learning models to generate the set of chapter code results 264, such as, for example, one or more trained text classification models 274 and/or any other suitable search models. The set of chapter code results 264 may be provided directly to the code designation determination engine 256 for inclusion in a generated interface 258 and/or can undergo additional processing (e.g., post-processing 290) to select a set of code designation determination results (e.g., country-specific results 358) for presentation to a user via the generated interface 258. Based on the query 255, the code designation determination engine 256 also generates a country-specific request 266. The country-specific results 358 are generated in response to the country-specific request 266 and the output from the multimodal fusion model 356.

FIG. 8 is an example process flow 800 illustrating various steps of predicting a code designation, in accordance with some embodiments. In addition to receiving a request for determining a code designation of an item, the server also receives one or more data elements 802 representative of features of the item (e.g., item-specific data elements 802). The one or more data elements 802 may include textual information 804 (e.g., textual description about the item) and/or image data 806 (e.g., one or more images associated with the item).

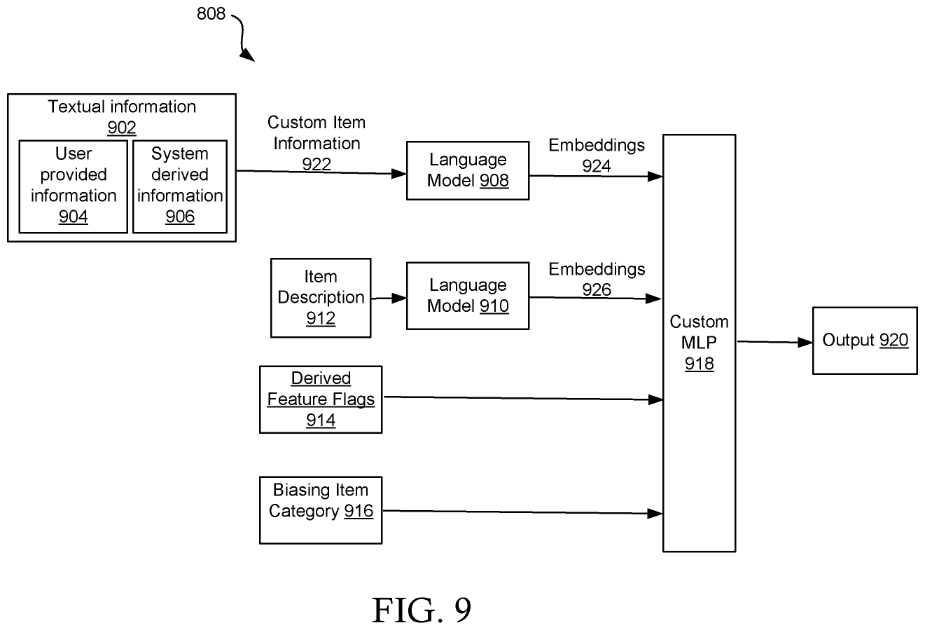

In some embodiments, textual information 804 includes user provided text that is entered by a user via a web form, such as a name or a title of an item (e.g., Brand A pencils, Brand B three-season tent, Brand C insulated gloves, etc.), a category of the item, such as a product category (e.g., clothing, man's clothing, shoes, perfume, sports gear, cutlery, etc.), different attributes of the item, such as material attributes of the item (e.g., synthetic, insulating, biodegradable, flammable, etc.), and/or any other textual data elements, such as those described further in reference to FIG. 9.

In some embodiments, image data 806 of an item includes image or video data associated with the item for which the code designation (e.g., HTS code classification, HS code, etc.) is to be determined. For example, the image data 806 may be image or video data of the item that is uploaded by the user and/or the image data 806 of the item may be (e.g., automatically and/or in response to selection of an item) retrieved from a database, such as database 14.

In some embodiments, the one or more data elements 802, or a subset thereof, are treated as an item description including at least one of textual information or image information. In some embodiments, text-based and image-based models are combined to create a composite model, such as meta classifier 812. Such composite models may provide better prediction of HTS codes by combining textual information with the image information. For example, when data from one modality (e.g., text of image) is missing or ambiguous, the methods and systems described herein are still able to rely on the data from the available modality for determining the code designation.

In some embodiments, the output from subpart 824 of the process flow 800 includes a first portion of the code designation. For example, the first portion of the code designation may include the first six digits of the HTS code (also referred to as the HS code). In some embodiments, the HS code may be the same in different countries for a particular item. After the first portion of the code designation is obtained from the subpart 824 of the process flow 800, different country-specific classifiers (e.g., classifier 814 for a first country, classifier 816 for a second country, or classifier 818 for a third country) may be used to generate the full code designation (e.g., the full HTS code) in a respective country. Post processing 820 may be applied to ensure accuracy of the determined code designation before the process flow 800 provides a predicted full code designation 826 as an output. For example, the process flow 800 also includes performing chapter code prediction via a chapter code prediction model 822, described in reference to FIG. 12, as part of post processing 820.

FIG. 9 illustrates an example text classification model 808, in accordance with some embodiments. Textual information 902 (e.g., textual data 804), which can include user provided textual information 904 and system derived information 906, may be provided to the text classification model 808. For example, the user provided textual information 904 may be entered via a web form when an item is listed on a server (e.g., an item listed for sale on a server) and/or may be obtained through one or more additional processes, such as a text extraction process to automatically extract relevant textual information from a scan (e.g., image) of a label of an item. In some embodiments, the server is configured to generate or extract additional information based on the user provided textual information 904. For example, the user provided textual information 904 may not include data for an expected data element (e.g., item category, material attribute, etc.). The server may then be configured to generate system derived information 906, based on the user provided textual information 904, to complete the missing data elements (e.g., the server may determine an item category of the item based on the item description in the user provided textual information 904).

The textual information 902 includes one or more of: an item title, an item category, item details such as the type of item, details about a fabric component of the item, details about a metal component of the item, details about the material components of the item, and page breadcrumbs. Page breadcrumbs refer to a navigational scheme (e.g., a secondary navigation scheme) provided by a server (e.g., a server having a large amount of content organized in a hierarchical manner) to access an item, and may be provided as textual information by the server or system (e.g., system derive information 906). Page breadcrumbs may also reveal a user's location in a website or a web application. For example, page breadcrumbs may be horizontally arranged text links separated by a “greater than” symbol (>) (or any other suitable format) that indicates the level of that page relative to the page links beside it. In some embodiments, page breadcrumbs show attributes of the items displayed on a particular page. In some embodiments, page breadcrumbs include path-based breadcrumb trails that show the steps a user has taken to arrive at a particular page.

In some embodiments, the text classification model 808 concatenates the textual information 902 to create custom item information 922 (e.g., custom item information text). The custom item information 922 may be provided to language model 908 to extract one or more embeddings 924 from the custom item information 922.

In some embodiments, the language model 908 includes pre-training, such as masked language modeling (MLM), and/or permuted language modeling (PLM). Such pretraining accounts for dependency among predicted tokens, and also leverages the full position information of a sentence to address position discrepancy between pre-training and fine-tuning. In some embodiments, the language model 908 has multilingual capabilities and includes MPNet pre-trained on large-scale datasets.

In some embodiments, language model 908 includes a MPNet model with Sentence-Transformers to extract (e.g., generate, obtain), from the textual information 902, pretrained embeddings 924 for textual features (e.g., embeddings 924 are the output of the language model 908, the language model may be paraphrase-multilingual-mpnet-base-v2). For example, in some embodiments, the language model 908 includes a transformer providing a sequence-to-sequence neural network architecture. Input text (e.g., textual information 902) may be encoded with tokenizers to obtain a sequence of integers called input tokens. The input tokens may be mapped to a sequence of vectors (e.g., word embeddings) via an embeddings layer. The output vectors (e.g., embeddings) may be classified to a sequence of output tokens, which can be decoded back into text. An example of such a language model is MPNet, which allows the language model to see a full sentence by taking auxiliary position information as input and reduces position discrepancy and accounts for dependency among predicted tokens through permuted language modeling.

In some embodiments, the text classification model 808 includes a language model 910 for processing text input from item description 912. In some embodiments, the item description 912 includes additional textual information about the item provided by a user obtained from another source (e.g., a catalog, a database), and/or derived from the user provided textual information 904 or system derived information 906. In some embodiments, the language model 910 may be similar to the language model 908 while including multilingual capabilities. For example, the language model 910 may be a MPNet model with Sentence-Transformers to extract (e.g., generate, obtain) pretrained embeddings 926 from the item description 912 in two or more languages.

In some embodiments, both the embeddings 924 and the embeddings 926 are provided as inputs to a trained multi-layer perceptron (MLP) 918. For example, the embeddings 924 include a sequence of tokens representing at least a portion of the custom item information 922. The MLP 918 is configured to classify a portion of the HTS code (e.g., the first 6 digits of HTS code, other portion of the HTS code, the entirety of the HTS code, etc.) using the embeddings 924 and the embeddings 926, which are generated from the textual information 902, and item description 912, respectively.

The MLP 918 also receives, as input, in some embodiments, derived feature flags 914. The derived feature flags 914 may be extracted from the textual information 902, for example, based on the material attributes (e.g., a flag of “aluminum,” “leather,” or “polyester,” or “clothing”), fabric attributes, and/or metal attributes. The MLP 918 may also receive, as an input, a biasing item category 916. For example, the item categories may include a predetermined number (e.g., about 40-50) of the most commonly used item categories (e.g., apparel, furniture, shoes, etc.) and the biasing item category 916 may be a one-hot encoded input for one of the predetermined categories. In some embodiments, the item category (e.g., product category) corresponding to the one-hot encoding includes the item category contained in textual information 902 (e.g., provided by the user, derived by the system, etc.). Output 920 from the MLP 918 may include a probability distribution over the possible HS code classes.

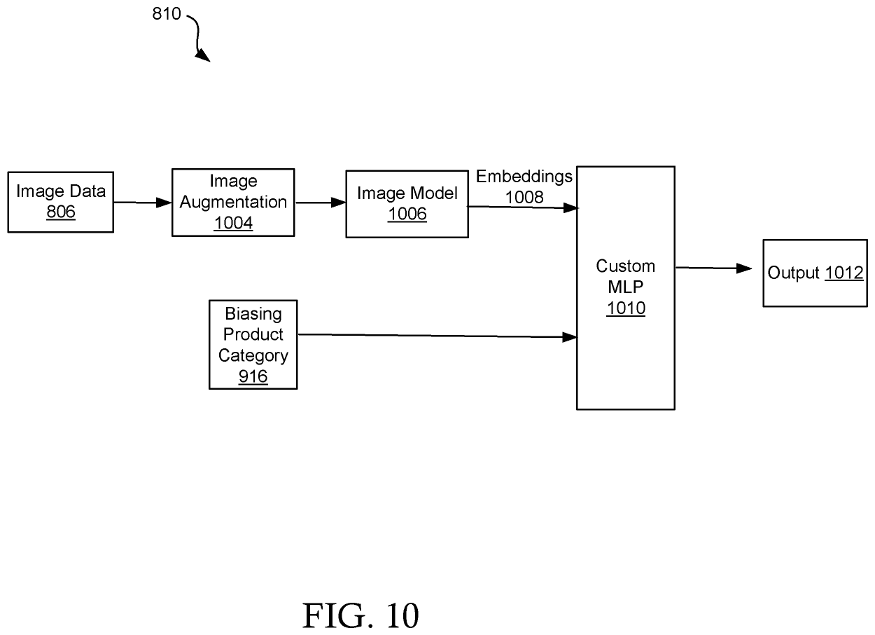

FIG. 10 illustrates an image classification model 810, in accordance with some embodiments. The image classification model 810 receives an input including image data 806 of an item for which a code designation (e.g., HTS code classification, HS code) is to be determined. In some embodiments, image data 806 may include an image file of the item provided by a user, retrieved from a database, and/or otherwise obtained by the image classification model 810. Image augmentation techniques 1004 are used to enhance the dataset by applying one or more transformations (e.g., rotation, flipping, scaling, translation, shearing, resizing, normalization, etc.) to the original images to obtain augmented images. The use of augmented images may increase the robustness of the image classification model 810 and/or improve the ability to generalize to unseen data by the image classification model 810.

The image data 806 and associated data from image augmentation techniques 1004 may be provided to an image model 1006. In some embodiments, the image model 1006 includes self-supervised learning techniques and/or a fully convolutional masked autoencoder framework that includes a new Global Response Normalization (GRN) layer (e.g., added to a ConvNeXt architecture) to enhance inter-channel feature competition (e.g., a ConvNeXt V2 image model). In some embodiments, the image classification model 810 employs an image model 1006 (e.g., a ConvNextV2 model) that is pre-trained on training dataset, such as the ImageNet-21k dataset, to generate image embeddings for the image data 806 (e.g., one or more images of the item). In some embodiments, image embeddings 1008 are obtained (e.g., extracted) by taking the output of the last convolutional layer of the image model 1006 and applying global average pooling.

The image embeddings 1008 and the biasing item category 916, as explained in reference to FIG. 9, may be provided to a trained multi-layer perceptron (MLP) 1010 to classify the HS codes (e.g., the first 6 digits of a HTS code). In some embodiments, the image embeddings 1008 are concatenated with the biasing item category 916 that is one-hot encoded, and provided as input to the MLP 1010. The output 1012 of the MLP 1010 is a probability distribution over the possible HS code classes.

Returning to FIG. 8, a meta classifier 812 receives, as input, the output from the text classification model 808 and the image classification model 810 and provides an output to one or more trained country-specific KNN classifiers (e.g., country-specific greedy KNN classifiers) to predict a portion of the HTS code (e.g., the remaining digits of the HTS code, the last six digits of the HTS code, etc.). A model for each modality (e.g., text and image) may be trained separately before representations from the respective final hidden layers of each modality are used to train a multimodal fusion model (e.g., the meta classifier 812). In some embodiments, the text embeddings 924 and 926, and the image embeddings 1008 are concatenated and provided to the meta classifier 812 to predict the first six digits of HTS code. Due to the multimodal nature of the fusion model, even if one of the modalities (e.g., text or image) is ambiguous or missing, the predicted portion of the HTS code is more accurate compared to models based on a single modality. In some embodiments, the meta classifier 812 includes a custom multi-layer perceptron model that has two hidden layers. The use of a multimodal approach provides more robust predictions that have higher accuracy and coverage, as compared to individual models. Coverage refers to the ability of the model to provide a prediction (e.g., a predicted code designation) for a particular item, while accuracy refers to whether the correct code designation is predicted for the item.

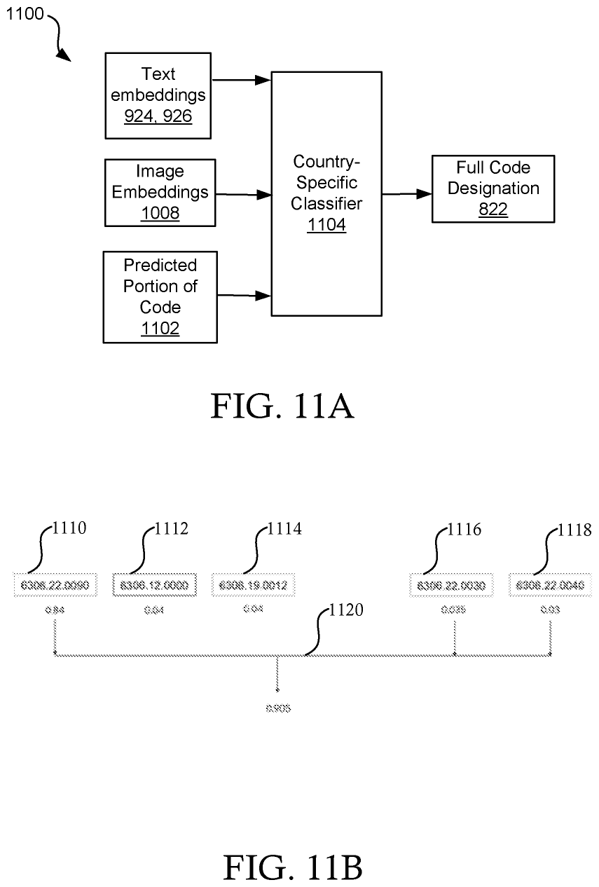

FIG. 11A illustrates a country-specific classification model 1100, in accordance with some embodiments. A trained country-specific classifier 1104 receives as input, text embeddings 924 and 926 from the text classification model 808, image embeddings 1008 from the image classification model 810, together with a predicted portion 1102 of the HTS code (e.g., the first six digits of the HTS code provided by the meta classifier 812). The country-specific classifier 1104 is configured to account for different customs rules of different countries. In some embodiments, the country-specific classifier 1104 includes a greedy classifier, for example, a country-specific KNN classification model. A greedy classifier may be configured to pick an element (e.g., option, possibility) based on limited (e.g., local or global) information, as opposed to a non-greedy algorithm that may explore all possibilities, and the greedy classifier may reduce a search space. A non-limiting example of a greedy algorithm includes a Nearest Neighbor algorithm. In some embodiments, the country-specific classifier 1104 is a K-Nearest Neighbor (KNN) classifier (e.g., selects K nearest neighbors for a giving input data point), that is used to predict a portion of the HTS (e.g., the remaining portion of the HTS, the last six digits of the HTS, etc.) based on the specific country's customs rules, using the predicted portion 1102 of the code designation from the meta classifier 812 (e.g., the first 6 digits of the HTS), and text and image embeddings from previously trained models (e.g., text embeddings 924 and 926, image embeddings 1008, etc.). The output of the country-specific classifier 1104 (e.g., combined with the predicted portion 1102 of the code designation) yields the full code designation 826 (e.g., HTS code).

In multi-class classification scenarios like those described above, where there are numerous classes to predict, it may be common to encounter dispersed probabilities due to the similarity between classes. To achieve both higher prediction accuracy and but also to attain greater coverage, a threshold confidence criterion may be set (e.g., a 90% confidence criterion, a 85% confidence criterion, a 95% confidence criterion, etc.). One or more post-processing steps may be used to meet the threshold confidence criterion by enhancing the coverage metrics (e.g., increasing the model's ability to provide a predicted code designation for an item) while maintaining accuracy (e.g., the predicted code designation being the correct code designation).

In some embodiments, post-processing may include an aggregation based on a first portion of the predicted code designation (e.g., predicted portion 1102 of the code designation, or the first 6 digits of the code designation). For example, HTS codes have a hierarchical structure. As a result, the more common digits there are at the beginning between two HTS codes, the greater the similarity between the two HTS codes. In some embodiments, items with the same HS codes are variations of each other, and may feature similar duty rates and may differ based on minor differences. For example, the code designation “6306.22.0030” is for “Tents made of nylon or other polyamides,” while the code designation “6306.22.0040,” refers to “Tents made of polyesters.” The code designation “6306.22.0090” is for “Tents made of other synthetic fibers.” All three code designations described above represent 6306.22, which is a grouping for “Tents made of synthetic fibers.” The models described herein would, for a tent item that has missing or ambiguous material information, output probabilities that are distributed among these classes. Thus, respective first portions of the candidate code designations (e.g., the first six digits) in the first subset of the plurality of candidate code designations are identical. In some cases, transmitting (e.g., as an intermediate output, or as a final output) a selected code designation includes transmitting, as the selected code designation, a code designation from the first subset of the plurality of candidate code designations that has a highest associated probability value (e.g., the code designation “6306.22.0090” in FIG. 11B) is automatically associated with the item the selected code designation.

Given the high overall accuracy of the models described herein, in some embodiments, post-processing that aggregates the probabilities based on the common first six digits (e.g., identical chapter, heading and sub-heading codes) for the top predicted code designation (e.g., the code designation having the highest probability, hereinafter also sometimes referred to as “top predicted HTS code”) may improve the coverage of the models described herein. In some embodiments, if the aggregated probability for the top predicted HTS code surpasses a predetermined confidence threshold (e.g., a 90% confidence criterion, a 85% confidence criterion, or a 95% confidence criterion), the item is automatically classified that HTS code (e.g., the top predicted HTS).

FIG. 11B is an example of aggregating code designations, in accordance with some embodiments. Code prediction 1110, code prediction 1116, and code prediction 1118 have the same first six digits of the HTS code (e.g., “6302.22”), giving a total probability (e.g., of 0.905) for the 6306.22 family that exceeds the predetermined confidence threshold (e.g., the predetermined confidence threshold is greater than 0.9, greater than 0.85, greater than 0.95, etc.). As a result, the item is automatically associated with the majority class as 6306.22.0090. In contrast, code prediction 1112, and 1114 are not including in the aggregation step of 1120 because they do not share the same first six digits of the code designation. In some embodiments, the probability of each class having the same first six digits of the HTS may be smaller (e.g., three classes each of about 0.31, summing to a total that exceeds the predetermined confidence threshold), which may suggest that the accuracy associated with any of the three classes is sufficient to automatically associate the item with the majority class (e.g., itself having a probability that may be below 0.5).

In some embodiments, post-processing includes the use of a chapter prediction model. The chapter prediction model is trained using only text data (e.g., textual information 804, textual information 902, item description 912, embeddings 924 and embedding 926) to predict a portion (e.g., the first two digits (or the chapter code)) of the HTS code. This model may have high accuracy and high coverage (e.g., most of the predictions have confidence higher than 90 percent) as it is used to predict just two digits (e.g., the first two digits, or a total of 100 possibilities).

The use of a chapter prediction model may be particularly useful in post-processing the outputs for mixed items (e.g., mixed products) where the code designations may have overlaps with multiple broad-level categories due to the nature of the mixed items (e.g., ambiguities due to the bundling of multiple different items). Examples of mixed items include, a ceramic sink bundled together with a metallic faucet, or a cell phone bundled with a phone charger. The ceramic sink has one code designation while the metallic faucet may have a different code designation, and thus there may be ambiguities in the code designation for the bundle. In some embodiments, the code designation for mixed items follows the code designation of the primary item (e.g., the ceramic sink, and/or the cell phone, instead of the faucet or the charger). In some embodiments, the chapter code model predictions help to determine a code designation for bundled items with higher confidence.

FIG. 12 is an example process flow for determining a code designation of an item, in accordance with some embodiments. The process flow 1200 includes using information about an item 1202 to make an item prediction 1204 about the item 1202. In some embodiments, the item prediction 1204 includes the full code designation 826 as described in FIG. 8 and FIG. 11A. In some embodiments, the item prediction 1204 includes a portion of the HTS code (e.g., the first six digits of the HTS code, or the HS code). In some embodiments, the item prediction 1204 includes a probability distribution of different code designations and their respective probabilities. In a step 1206, in accordance with a determination that a confidence level associated with the item prediction 1204 (e.g., the top prediction from the probability distribution, the code designation prediction having the highest probability) exceeds a threshold (e.g., a confidence threshold of 85%, a confidence threshold of 90%, a confidence threshold of 95%), the item 1202 is automatically classified as having the code designation of the item prediction 1204 in a step 1208. In the step 1206, in accordance with a determination that a confidence level associated with the item prediction 1204 does not exceed the threshold (e.g., a confidence threshold of 85%, a confidence threshold of 90%, a confidence threshold of 95%), the information about the item 1202 is provided to generate a chapter code prediction 1210. In some embodiments, the chapter code prediction 1210 is associated with the predicting the first two digits of the code designation (e.g., a total of 100 possibilities associated with the two digits). For example, the process flow 1200 obtain, via a second trained model for text classification (e.g., the chapter code prediction 1210), a candidate code portion (e.g., the chapter code portion, or the first two digits of the code designation) for the first portion of the code designation.

At step 1212, in accordance with a determination that the chapter code prediction 1210 matches the chapter code (e.g., the first two digits of the code designation) of the top prediction (e.g., the predicted code designation having the highest probability), the process flow 1200 moves to a step 1214 in which the probabilities of code designation predictions having the same first portion (e.g., the first portion includes the first digits of the code designation, the first portion is the HS code associated with the HTS code designation) are aggregated and scaled. In some embodiments, the aggregation may proceed as described in FIG. 11B. In some embodiments, scaling the probability distributions include normalizing the probabilities to a subset of the code predictions. For example, the chapter code may include codes associated with the first two digits of the code designation. Instead of considering all possibilities from 00 to 99 (e.g., a total of 100 possibilities), scaling the probabilities may include setting to zero a subset of the possibilities that are not applicable (e.g., reducing the 100 possibilities to a subset of 50 possible chapter codes). In the step 1212, in accordance with a determination that the aggregated and/or scaled probabilities of a predicted code designation meets a threshold (e.g., the threshold in step 1214 is the same as the threshold in the step 1206, the threshold in step 1214 is different from the threshold in the step 1206, the threshold is a confidence threshold of 85%, a confidence threshold of 90%, or a confidence threshold of 95%), the item 1202 is automatically classified as being associated with the top prediction in the step 1208.

In the step 1212, in accordance with a determination that the chapter code prediction 1210 does not match the chapter code (e.g., the first two digits of the code designation) of the top prediction (e.g., the predicted code designation having the highest probability), the process flow 1200 terminates the code designation determination for the item 1202. In such scenarios, the item 1202 would fall outside the coverage of the code designation determination systems and methods described herein. In some embodiments, an item that is not automatically associated with a determined code designation would have to be manually matched with the code designation (e.g., a manually determined HTS code).

A code designation determination system and method that provides higher coverage allows more items to be automatically classified with respective code designations (e.g., HTS codes), allowing a user to complete a listing process (e.g., onboarding) for the item more easily, allowing the item to be made available (e.g., for sale, or for browsing) sooner, and improving the efficiency of the listing process while enhancing user experience.

Identification of a code designation (e.g., HTS code, or HS code) associated with an item can be burdensome and time consuming for users, especially if only a subset of available information about the item is used in a classification system. When only product descriptions are used in the classification system, accuracy of the code designation (e.g., the item is matched to the correct HTS code or the correct HS code) may be impacted (e.g., the wrong code designation is determined by the classification system, or the classification system is unable to provide any code designation for the item). A user may locate information regarding a code designation by navigating a browse structure, sometimes referred to as a “browse tree,” in which code designations are arranged in a predetermined hierarchy. Such browse trees typically include multiple hierarchical levels, requiring users to navigate through several levels of browse nodes or pages to arrive at a code designation of interest. Thus, the user frequently has to perform numerous navigational steps to arrive at a page containing information regarding the code designation of an item.

Systems including trained a language model that includes pre-training and includes masked language modeling (MLM), and permuted language modeling (PLM) such as a multilingual MPNet model with Sentence-Transformers, and/or an image model that includes self-supervised learning techniques and a fully convolutional masked autoencoder framework such as a ConvNeXt V2 image model, and a meta-classifier (e.g., meta classifier 812) as disclosed herein, significantly reduce this problem, allowing users to determine a code designation of an item with fewer, or in some case no, active steps. Beneficially, programmatically determining a code designation for an item and presenting a user with items that includes automatically navigations shortcuts to related designation tasks may improve the speed of the user's navigation through an electronic interface.

It will be appreciated that determining a code designation associated with an item as disclosed herein, particularly on large datasets intended to be used for image classification of the item or for generating embeddings from the image data associated with the item, is only possible with the aid of computer-assisted machine-learning algorithms and techniques, such as a language model that includes pre-training and includes masked language modeling (MLM), and permuted language modeling (PLM) such as a multilingual MPNet model with Sentence-Transformers, and/or an image model that includes self-supervised learning techniques and a fully convolutional masked autoencoder framework such as a ConvNeXt V2 image model, and a meta-classifier (e.g., meta classifier 812). In some embodiments, machine learning processes including a language model that includes pre-training and includes masked language modeling (MLM), and permuted language modeling (PLM) such as a multilingual MPNet model with Sentence-Transformers, and/or an image model that includes self-supervised learning techniques and a fully convolutional masked autoencoder framework such as a ConvNeXt V2 image model, and a meta-classifier (e.g., meta classifier 812) are used to perform operations that cannot practically be performed by a human, either mentally or with assistance, such as determining a code designation associated with an item.

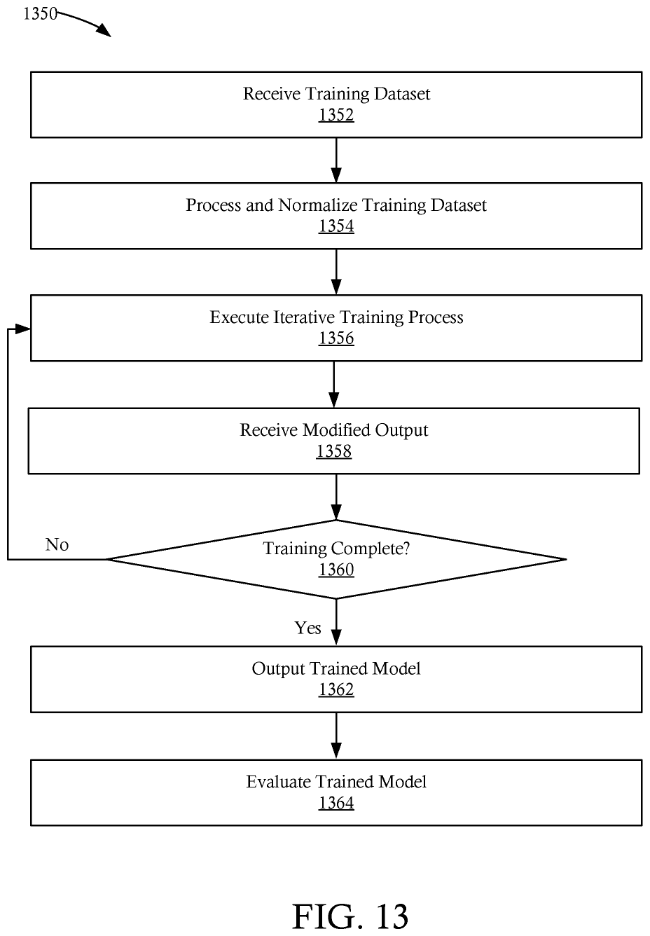

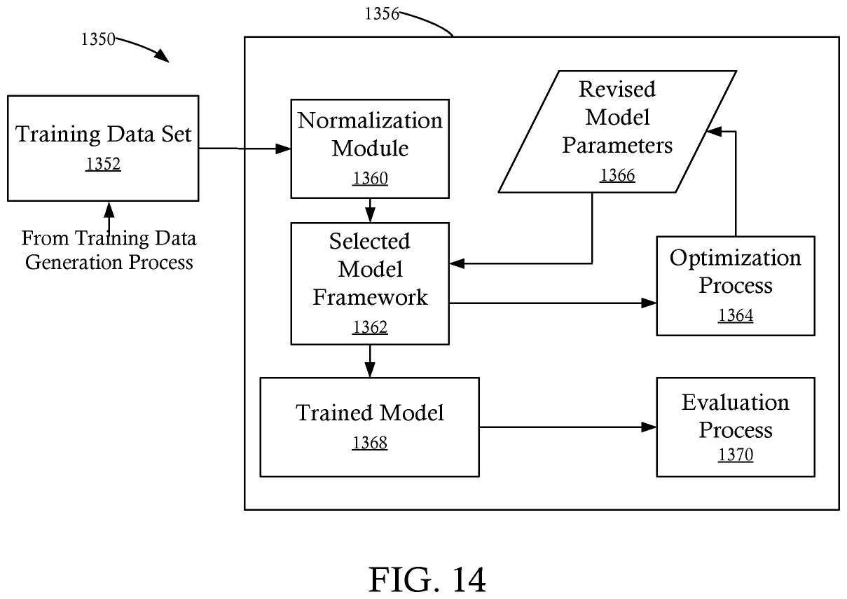

In some embodiments, a code designation determination engine 256 can include and/or implement one or more trained models, such as a language model that includes pre-training and includes masked language modeling (MLM), and permuted language modeling (PLM) such as a multilingual MPNet model with Sentence-Transformers, and/or an image model that includes self-supervised learning techniques and a fully convolutional masked autoencoder framework such as a ConvNeXt V2 image model. In some embodiments, one or more trained models can be generated using an iterative training process based on a training dataset. FIG. 13 illustrates a method 1250 for generating a trained model, such as a trained optimization model, in accordance with some embodiments. FIG. 14 is a process flow 1350 illustrating various steps of the method 1250 of generating a trained model, in accordance with some embodiments. At step 1252, a training dataset 1352 is received by a system, such as a processing device 10. The training dataset 1352 can include labeled and/or unlabeled data. In some embodiments, the training dataset 1352 includes ImageNet-21k dataset, and augmented image datasets based on image data associated with the item that is provided by a user or retrieved from a relevant database.

At optional step 1254, the received training dataset 1352 is processed and/or normalized by a normalization module 1360. For example, in some embodiments, the training dataset 1352 can be augmented by imputing or estimating missing values of one or more features associated with an item, including one or more of: an item title, an item category, item details such as the type of item, details about a fabric component of the item, details about a metal component of the item, details about the material components of the item. In some embodiments, processing of the received training dataset 1352 includes outlier detection configured to remove data likely to skew training of a code designation determination engine and/or one or more sub-models. In some embodiments, processing of the received training dataset 1352 includes removing features that have limited value with respect to training of the code designation determination engine and/or one or more sub-models.

At step 1256, an iterative training process is executed to train a selected model framework 1362. The selected model framework 1362 can include an untrained (e.g., base) machine learning model, and/or a partially or previously trained model (e.g., a prior version of a trained model). The training process is configured to iteratively adjust parameters (e.g., hyperparameters) of the selected model framework 1362 to minimize a cost value (e.g., an output of a cost function) for the selected model framework 1362.

The training process is an iterative process that generates set of revised model parameters 1366 during each iteration. The set of revised model parameters 1366 can be generated by applying an optimization process 1364 to the cost function of the selected model framework 1362. The optimization process 1364 can be configured to reduce the cost value (e.g., reduce the output of the cost function) at each step by adjusting one or more parameters during each iteration of the training process.

After each iteration of the training process, at step 1258, a determination is made whether the training process is complete. The determination at step 1258 can be based on any suitable parameters. For example, in some embodiments, a training process can complete after a predetermined number of iterations. As another example, in some embodiments, a training process can complete when it is determined that the cost function of the selected model framework 1362 has reached a minimum, such as a local minimum and/or a global minimum.

At step 1260, a trained model 1368, such as a language model that includes pre-training and includes masked language modeling (MLM), and permuted language modeling (PLM) such as a multilingual MPNet model with Sentence-Transformers, and/or an image model that includes self-supervised learning techniques and a fully convolutional masked autoencoder framework such as a ConvNeXt V2 image model, and a meta-classifier (e.g., meta classifier 812) are output and provided for use to determine a code designation associated with an item, such as the code designation determination method 200 discussed above with respect to FIGS. 6-7. At optional step 1264, a trained model 1368 can be evaluated by an evaluation process 1370. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a database configured to store a trained text classification model and a trained image classification model;
a processor communicatively coupled to the non-transitory memory, wherein the processor is configured to read a set of instructions to:
receive, from a requesting system, a request for a code designation of an item;
receive, from the requesting system, a textual description and one or more images associated with the item;
obtain, via the trained text classification model, a first probability distribution associated with a first portion of the code designation from the textual description;
obtain, via the trained image classification model, a second probability distribution associated with the first portion of the code designation from the one or more images;
generate a plurality of candidate code designations based on the first probability distribution and the second probability distribution, wherein each candidate code designation in the plurality of candidate code designations comprises the first portion of the code designation and a second portion of the code designation;
aggregate respective probabilities of respective candidate code designations in a first subset of the plurality of candidate code designations; and
in accordance with a determination that an aggregated probability of the first subset of the plurality of candidate code designations is larger than a threshold:
transmit a selected code designation from the first subset of the plurality of candidate code designations to the requesting system as the code designation associated with the item.

2. The system of claim 1, wherein the first portion of each candidate code designation in the first subset of the plurality of candidate code designations are identical, wherein the selected code designation comprises a code designation from the first subset of the plurality of candidate code designations that has a highest probability value, and wherein the item is automatically associated with the selected code designation.

3. The system of claim 1, wherein the trained text classification model is configured to receive, as an input, text embeddings generated from the textual description of the item, and wherein the trained text classification model comprises a multi-layer perceptron trained to classify the first portion of the code designation.

4. The system of claim 3, wherein the trained text classification model is configured to receive, as a second input, item category data for the item based on the textual description of the item.

5. The system of claim 1, wherein the processor is further configured to:
in accordance with a determination that the aggregated probability of the first subset of the plurality of candidate code designations is not greater than the threshold:
obtain, via a second trained text classification model, a candidate code portion for the first portion of the code designation; and
in accordance with a determination that the candidate code portion for the first portion of the code designation matches a corresponding portion of a candidate code designation from the first subset of the plurality of candidate code designations, transmit the candidate code designation to the requesting system.

6. The system of claim 1, wherein generating the plurality of candidate code designations based on the first probability distribution and the second probability distribution comprises generating the second portion of the code designation from the textual description of the item and the one or more images using a country-specific classifier.

7. The system of claim 1, wherein the trained image classification model is configured to receive, as an input, image embeddings generated from the one or more images associated with the item, and wherein the trained image classification model comprises a multi-layer perceptron trained to classify the first portion of the code designation.

8. The system of claim 7, wherein augmented images of the one or more images are added to a database that trains a model used for generating the image embeddings from the one or more images.

9. A computer-implemented method, comprising:
receiving, from a requesting system, a request for a code designation of an item;
receiving, from the requesting system, a textual description and one or more images associated with the item;
obtaining, via a trained text classification model, a first probability distribution associated with a first portion of the code designation from the textual description;
obtaining, via a trained image classification model, a second probability distribution associated with the first portion of the code designation from the one or more images;
generating a plurality of candidate code designations based on the first probability distribution and the second probability distribution, wherein each candidate code designation in the plurality of candidate code designations comprises the first portion of the code designation and a second portion of the code designation;
aggregating respective probabilities of respective candidate code designations in a first subset of the plurality of candidate code designations; and
in accordance with a determination that an aggregated probability of the first subset of the plurality of candidate code designations is larger than a threshold, transmitting a selected code designation from the first subset of the plurality of candidate code designations to the requesting system as the code designation associated with the item.

10. The computer-implemented method of claim 9, wherein the first portion of each candidate code designation in the first subset of the plurality of candidate code designations are identical, wherein the selected code designation comprises a code designation from the first subset of the plurality of candidate code designations that has a highest probability value, and wherein the item is automatically associated with the selected code designation.

11. The computer-implemented method of claim 9, further comprising:
in accordance with a determination that the aggregated probability of the first subset of the plurality of candidate code designations is not greater than the threshold:
obtaining, via a second trained text classification model, a candidate code portion for the first portion of the code designation; and
in accordance with a determination that the candidate code portion for the first portion of the code designation matches a corresponding portion of a candidate code designation from the first subset of the plurality of candidate code designations, transmitting the candidate code designation to the requesting system.

12. The computer-implemented method of claim 9, wherein generating the plurality of candidate code designations based on the first probability distribution and the second probability distribution comprises generating the second portion of the code designation from the textual description of the item and the one or more images using a country-specific classifier.

13. The computer-implemented method of claim 9, wherein the trained image classification model is configured to receive, as an input, image embeddings generated from the one or more images associated with the item, and wherein the trained image classification model comprises a multi-layer perceptron trained to classify the first portion of the code designation.

14. The computer-implemented method of claim 13, further comprising adding augmented images of the one or more images to a database that trains a model used for generating the image embeddings from the one or more images.

15. A non-transitory computer-readable medium having instructions stored thereon that, when executed by a processor, cause a device to perform operations comprising:
receiving, from a requesting system, a request for a code designation of an item;
receiving, from the requesting system, a textual description and one or more images associated with the item;
obtaining, via a trained text classification model, a first probability distribution associated with a first portion of the code designation from the textual description;
obtaining, via a trained image classification model, a second probability distribution associated with the first portion of the code designation from the one or more images;
generating a plurality of candidate code designations based on the first probability distribution and the second probability distribution, wherein each candidate code designation in the plurality of candidate code designations comprises the first portion of the code designation and a second portion of the code designation;
aggregating respective probabilities of respective candidate code designations in a first subset of the plurality of candidate code designations; and
in accordance with a determination that an aggregated probability of the first subset of the plurality of candidate code designations is larger than a threshold:
transmitting a selected code designation from the first subset of the plurality of candidate code designations to the requesting system as the code designation associated with the item.

16. The non-transitory computer-readable medium of claim 15, wherein the trained text classification model is configured to receive, as an input, text embeddings generated from the textual description of the item, and wherein the trained text classification model comprises a multi-layer perceptron trained to classify the first portion of the code designation.

17. The non-transitory computer-readable medium of claim 16, wherein the trained text classification model is configured to receive, as a second input, item category data for the item based on the textual description of the item.

18. The non-transitory computer-readable medium of claim 15, wherein the first portion of each candidate code designation in the first subset of the plurality of candidate code designations are identical, wherein the selected code designation comprises a code designation from the first subset of the plurality of candidate code designations that has a highest probability value, and wherein the item is automatically associated with the selected code designation.

19. The non-transitory computer-readable medium of claim 15, wherein generating the plurality of candidate code designations based on the first probability distribution and the second probability distribution comprises generating the second portion of the code designation from the textual description of the item and the one or more images using a country-specific classifier.

20. The non-transitory computer-readable medium of claim 15, wherein the trained image classification model is configured to receive, as an input, image embeddings generated from the one or more images associated with the item, and wherein the trained image classification model comprises a multi-layer perceptron trained to classify the first portion of the code designation.
